(19) United States
(12) Patent Application Publication
(10) Pub. No.: US 2006/0153117 A1
(43) Pub. Date: Jul. 13, 2006

(54) Method and apparatus for bandwidth provisioning in a wlan

(76) Inventors: Guillaume Bichot, La Chapelle Chaussee (FR); Shaily Verma, Powai (IN)

Correspondence Address: THOMSON LICENSING INC., PATENT OPERATIONS, PO BOX 5312, PRINCETON, NJ, 08543-5312, US

(21) Appl. No.: 10/541,763

(22) PCT Filed: Jan. 9, 2004
(86) PCT No.: PCT/IB04/00672

§ 371 Date: Jul. 11, 2005

Related U.S. Application Data
(60) Provisional application No. 60/439,085, filed on Jan. 9, 2003.

(51) Int. Cl. H04B 7/185

(52) U.S. Cl. 370/316

(57) ABSTRACT

The invention provides for a receiver transmitter comprising: a plurality of logical access points; for downloading a duration into a mobile terminal in accordance with an access point determination of the maximum amount of time information linked with a downlink broadcast traffic to deliver all the broadcast/multicast information in a single communication stream. The invention also provides for a method of broadcast/multicast frames “Duration” are set to values in order to deliver all the broadcast/multicast information in a single communication stream eliminating the requirement for contending for the medium for each broadcast/multicast frame transmission. This pseudo-reservation of the wireless medium can also be made periodic for enabling broadcast/multicast services.

This application claims the benefit of U.S. Provisional Application No. 60/439,085, filed Jan. 9, 2003.

The invention provides an apparatus and a method to extend the capacity of a WLAN by provisioning resources to a wireless station in response to a wireless access point determination of frame duration. The invention is particularly suitable for implementation in a system operating in accordance with the Institute of Electrical & Electronics Engineers' IEEE 802.11 standards.

### DESCRIPTION OF RELATED ART

The context of the present invention is the family of wireless local area networks or WLAN based upon the IEEE 802.11 standards which define access points that provide access for mobile devices and to other networks, such as hard wired local area and global networks, such as the Internet. Wireless receiving points utilized in access broadcast video streaming may include a settop box in a simple system, whereas in commercial rebroadcast system a transcoder/multiplexer/demultiplexer or TMD may operate in conjunction with a local video server. In receiving Internet data, a common gateway operating in a conventional IP/TCP protocol may be utilized.

The IEEE 802.11 based architecture is comprised of several components and services that interact to provide station mobility transparent to the higher layers of the network stack. The IEEE 802.11 based network defines a station as the component that connects to a wireless medium and contains the functionality of the IEEE 802.11 protocols, that being MAC (Medium Access Control), PHY (Physical Layer), and a connection to the wireless media. Typically, the IEEE 802.11 protocols are implemented in the hardware and/or software of a network interface card. This invention proposes a method for implementing a bandwidth reservation mechanism in an access point compatible with the IEEE 802.11 WLAN MAC layer for downlink traffic (i.e. from the base station to the terminal).

The IEEE 802.11 standards also define a Basic Service Set or BSS, which is regarded as a basic building block in WLAN architecture. The BSS consists of a group of any number of access point stations that communicate with one another. In independent BSS, the mobile stations communicate directly with each other. In an infrastructure BSS, all stations in the BSS communicate with the access point and no longer communicate directly with the independent BSS, such that all frames are relayed between stations by the access point.

A station could be a laptop PC, handheld device, or an access point (referred herein as “access point or AP”). Stations may be mobile, portable, or stationary and all stations support the IEEE 802.11 station services of authentication, de-authentication, privacy, and data delivery.

The MAC layer's primary function is to provide a fair mechanism to control access of shared wireless media. However, prior to transmitting a frame, the MAC layer must gain access to the network, which it does through two different access mechanisms: a contention-based mechanism, called the distributed coordination function (DCF), and a centrally controlled access mechanism, called the point coordination function (PCF).

The PCF modes allow the implementation of a quality of service (QOS) mechanism, but it is optional and requires extra interactions in order to negotiate a QOS between the mobile terminal and the AP. The DCF mode, considered the default mode, does not provide any QOS mechanism. Consequently all stations including the base station AP in WLAN have the same probability to acquire and to send data within the medium. This type of service is referred to as a “best effort”. This invention relates to the DCF mode, maintaining compatibility with the current AP standard for bandwidth allocation in the downlink, and thus, prioritizes a video broadcast or multicast downlink stream.

Three interframe space (IFS) intervals defer an IEEE 802.11 station's access to the medium and provide various levels of priority. Each interval defines the duration between the end of the last symbol of the previous frame to the beginning of the first symbol of the next frame. The Short Interframe Space (SIFS) provides the highest priority level by allowing some frames to access the medium before others, such as an ACK frame, a Clear-to-Send (CTS) frame, or a fragment of a previous data frame.

Simultaneous transmit attempts lead to collisions in the downlink, since only one transport stream can be transmitted during any one period. The problem is particularly acute during periods of high traffic loads and may render the protocol unstable. The IEEE 802.11 MAC layer uses collision avoidance rather than collision detection in order to simultaneously transmit and receive data. To resolve collisions, subsequent transmission attempts are typically staggered randomly in time using a binary exponential backoff. The DCF uses physical and virtual carrier sense mechanisms (carrier sense multiple access with collision avoidance (CSMA/CA)) with a binary exponential backoff that allows access attempts after sensing the channel for activity.

To assist in allocating optimum wait intervals, the IEEE 802.11 MAC implements a network allocation vector (NAV). The NAV is a counter the value of which indicates to a wireless station the amount of time that remains before the medium will become available. The NAV is kept current through “duration” values that are transmitted in all frames. The invention herein computes an optimum duration and fixes it.

By combining the virtual carrier sensing mechanism, using the NAV count, with the physical carrier sensing mechanism, the MAC implements the collision avoidance portion of the CSMA/CA access mechanism. If both mechanisms indicate that medium in not in use for an interval of a SIFS then the station will begin to transmit the frame. However, if the medium is not busy then the backoff algorithm is applied.

The protocol also suggests an optional use of request to send (RTS) and clear to send (CTS) frame exchange between source and destination stations to cope with hidden nodes (i.e. nodes that are in the range of the receiver but not a sender). RTS is transmitted from a source station to a destination station and CTS is a response initiated by the destination station to the source station. This initial handshake is followed by the minimal MAC frame exchange.

The invention provides a system to broadcast/multicast frame “duration” set to values in order to deliver multiple frames of broadcast/multicast information in a single communication stream eliminating the requirement for contending for the medium for each broadcast/multicast frame transmission. This pseudo-reservation of the wireless medium can also be made periodic for enabling broadcast/multicast services.

If the broadcast or multicast originator is a mobile terminal, broadcast or multicast data are first transferred from the terminal to the AP a unicast transmission. According to the IEEE 802.11 specifications, the broadcast/multicast message may be distributed into the BSS by the AP. Regardless of the length of the frame, no RTS/CTS exchange can be used. In addition, no ACK is permitted to be transmitted to the AP by any of the recipients of the frame. There is no MAC-level recovery on broadcast or multicast frames sent from the AP.

The AP transmits broadcast or multicast frames as received from the wired backbone. The AP also maintains statistical information about its probability to acquire the medium. According to its information and the throughput allocated for the downlink traffic that has to be prioritized, the AP computes the time required to send the maximum amount of information linked with this prioritized traffic (e.g. downlink broadcast traffic). For example, if the AP finds that the statistical probability of it acquiring the medium is ‘P’ frames per second and that it can send a maximum of ‘M’ bits per MAC frame while it has to send a total of ‘D’ bits for the prioritized service then it knows that it needs approximately:
(D bits)÷(M bits/frame)÷(P frames/s)=D/(M*P) sec for sending out the data.

In an example where the AP has to stream a service corresponding to ‘Dbr’ bps. Taking into account ‘P’, it has to send M bits per MAC frame with:
M=Dbr÷P

The “Duration” in the MAC header corresponds to the time to transmit the maximum-sized MAC frame, expanded by WEP, plus the time to transmit the PHY preamble, header, trailer, and expansion bits, if any.

### SUMMARY OF THE INVENTION

In an embodiment of the invention an access point communicates a “duration” values in order to deliver multiple frames of broadcast/multicast information in a single communication stream eliminating the requirement for contending for the medium for each broadcast/multicast frame transmission. The duration value is used to set the Network Allocation Vector (NAV). The NAV is a counter that is embedded in each 802.11 compliant device. The NAV counter is updated by each station by reading the duration information present in the header of all 802.11 compliant packets.

In another embodiment of the invention a wireless station downloads a “duration” set to values in order to deliver multiple frames of broadcast/multicast information in a single communication stream eliminating the requirement for contending for the medium for each broadcast/multicast frame transmission.

The invention provides for a method to produce contention-free sessions to reduce interference between overlapping first and second wireless LAN cells contending for the same medium. In a location containing a plurality of member stations and an access point station, the method for contention-free sessions includes a fixed cycle time that reduces conflicts from other mobile stations by determining a duration interval that is sufficiently long to transmit one or more frames in uninterrupted succession. The active access point sets a duration for the broadcast/multicast frames and communicates the duration to the downlink wireless stations, reducing conflicts from other cells. To lessen the contention between access point of different cells, each station's Network Allocation Vector (NAV) duration value is fixed by a value determined by the access point to be the duration required to broadcast/multicast information in a single communication stream.

A further embodiment of the invention includes a method for reducing contention conflicts among devices comprising the steps of: receiving digital packets embedded in a program, computing duration for transmission of an uninterrupted plurality of the broadcast/multicast frames and downlinking the new duration to wireless stations.

### BRIEF DESCRIPTION OF THE DRAWINGS The invention is described with the following detailed description with the accompanying drawings.

FIG. 1 is a block diagram of a conditional access system.

FIG. 2 is a block diagram of a WLAN wireless access point system of the present invention.

FIG. 3 is a block diagram of a method of the present invention.

FIG. 4 illustrates a distributed random access control as specified by the IEEE 802.11 standard.

FIG. 5 illustrates an access control based on NAV overestimating of the present invention.

### DETAILED DESCRIPTION OF THE INVENTION

In the figures to be discussed the circuits and associated blocks and arrows represent functions of the process according to the present invention which may be implemented as electrical circuits, and associated wires or data busses, which transport electrical signals, and/or software modules. Alternatively, one or more associated arrows may represent communication (e.g., data flow) between software routines, particularly when the present method or apparatus of the present invention is implemented as a digital process.

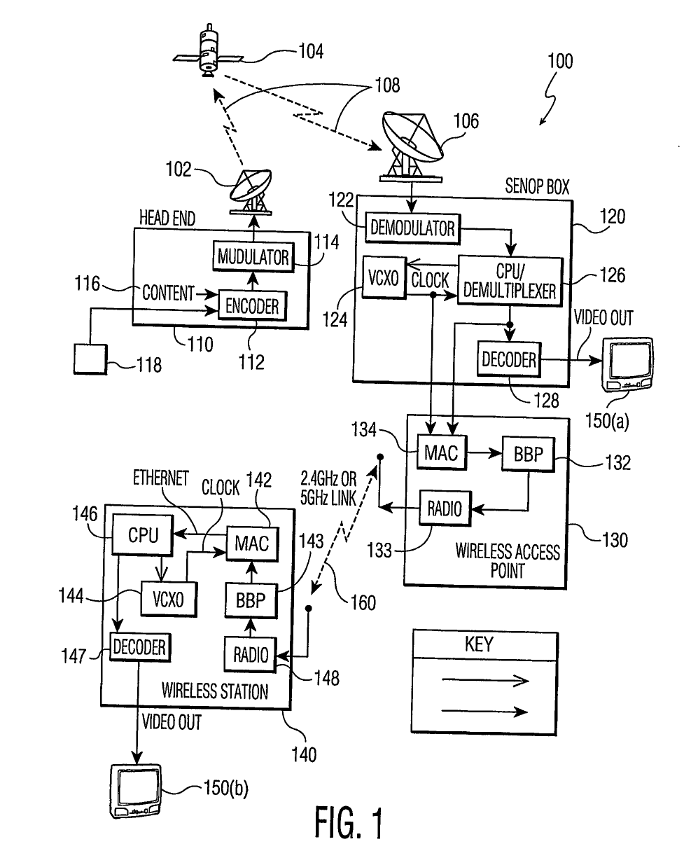

In accordance with FIG. 1, a head end 110 digitally formats video and audio content 116 in an encoder 112 which are modulated 114 so as to be transmitted from a transmitter 102 via satellite 104 to a receiving dish 106 located at a receiving end for television service to conditional access customers.

The receiving end typically is a set top box or TMD 123 (both referred to as a TMD) operating in conjunction with a local video server 120 which electronically connects to the receiving dish 106. The TMD 123 contains a demodulator (not shown) that demodulates the composite video and audio data signal, various administrative and control messages and outputs the demodulated signal to a central processing unit (not shown) that processes the many packetized streams by routing select packets to various control, data and status subsystems. For example, typically the selected packetized video and audio stream is sent to a decoder (not shown) for translation into a format suitable for an ultimate output to a mobile terminal also referred to more generally as a wireless station 140, which serves as the receiving device for devices such as a television 150 operating in accordance with NTSC, PAL or SECAM formats, or laptop computer, cell phone or PDA all designated by reference 152 and operating in accordance with IEEE 802.11 standards.

A wireless compliant device may comprise wireless station 140, which may in turn depict a laptop personal computer, a handheld device, or an access point 130 which manages other wireless stations, such as wireless station 140. Therefore, stations may be mobile, portable, or stationary and all stations that are IEEE 802.11 compliant provide authentication, de-authentication, privacy, and data delivery.

An IEEE 802.11 compliant system is comprised of several components, each of which contains a Medium Access Control or MAC 134, 142, Base Band Process or BBP 132,143, and radio receiver/transmitters 138,144 as well as services that interact to provide station mobility transparent to the higher layers of the network stack. However, a station is any device that contains the functionality of the IEEE 802.11 protocols, that being MAC and Physical Layer or PHY, and a connection to the wireless media such as one or more wireless stations 140. Typically, the IEEE 802.11 protocols are implemented in the hardware and/or software of a network interface card (not shown). By way of example, the wireless station 130 connects to other wireless medium such as wireless station 140 through a radio communication medium.

According to the IEEE 802.11 specifications, the NAV counter is updated by each station by reading the duration information present in the header of all IEEE 802.11 packets. The duration value is computed by the transmitter according to the specification. The invention herein discloses, in the context of video broadcasting or multicasting, an access point as the unique transmitter of the radio interface, which updates the duration information of each downlink packet in order to guarantee the delivery of a certain throughput.

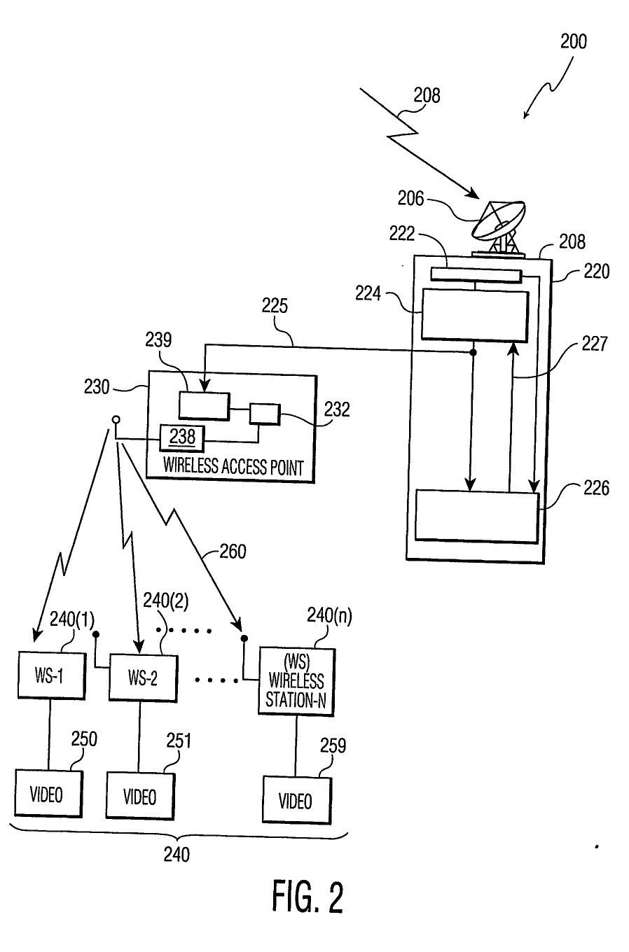

Referring to FIG. 2 a device 220 receives digital packets embedded in a transmission stream from a broadcast network or a hard wired local area network or Internet gateway, which also includes a means to demultiplex 222 digital packets embedded in a video frame transmission. The device 220 communicates with a device 230 that includes a means 234 for receiving the digital packets and includes a means for computing a 232 a duration for transmission of an uninterrupted plurality of the broadcast/multicast frames and a means 238 to communicate the duration to one or more wireless stations 240(1) through 240(n).

Referring to FIG. 2, the invention disclosed herein includes an access point 230 comprising: a means for receiving an IEEE 802.11 compliant frame transmission representing video programs in the form of digital packets from device 220 and during a beacon period determining the number of packets it needs to communicate an uninterrupted transmission and thereby computing a time duration corresponding to the length of time needed for downlinking via transmission 260 a plurality of uninterrupted broadcast/multicast frames.

An aspect of the invention includes any device such as access point 230 that receives digital packets embedded in a transmission stream 225 comprising: a means to receive digital packets 234; a means for computing a duration 232 for transmission of an uninterrupted plurality of the broadcast/multicast frames; a means to communicate 238 the duration to wireless stations 240 to reduce contention conflicts among wireless stations.

The invention also includes a device, such as represented by wireless device 240(1) through 240(n) that receives digital packets embedded in a transmission stream 260 comprising: a means for receiving a duration value for transmission of an uninterrupted plurality of the broadcast/multicast frames of a video frame transmission to provide for an uninterrupted plurality of broadcast/multicast frames.

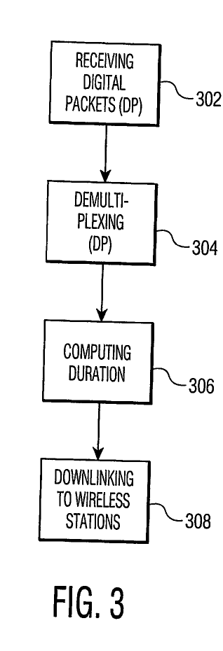

With reference to FIG. 2 and FIG. 3, the present invention includes a method for reducing contention conflicts in a broadcast/multicast environment comprising the steps of: coordinating by a first station 230 a contention-free communication 260 by computing a time duration 306 and communicating 308 the duration to the wireless stations such that a communication stream to at least one of the wireless stations 240 is uninterrupted for the duration 306. The duration is guaranteed in an IEEE 802.11 compliant device by operating on the NAV in the devices in the WLAN.

An embodiment of the present invention may be better understood with reference to FIG. 3 which details the steps of receiving 302 digital packets embedded in the program 208 from a IEEE 802.11 compliant source, demultiplexing digital packets 304 embedded in a means for receiving a IEEE 802.11 compliant digital packets of a video frame transmission; computing a duration 306 for transmission of an uninterrupted plurality of the broadcast/multicast frames and downlinking 308 the new duration to wireless stations, reducing contention conflicts among cells.

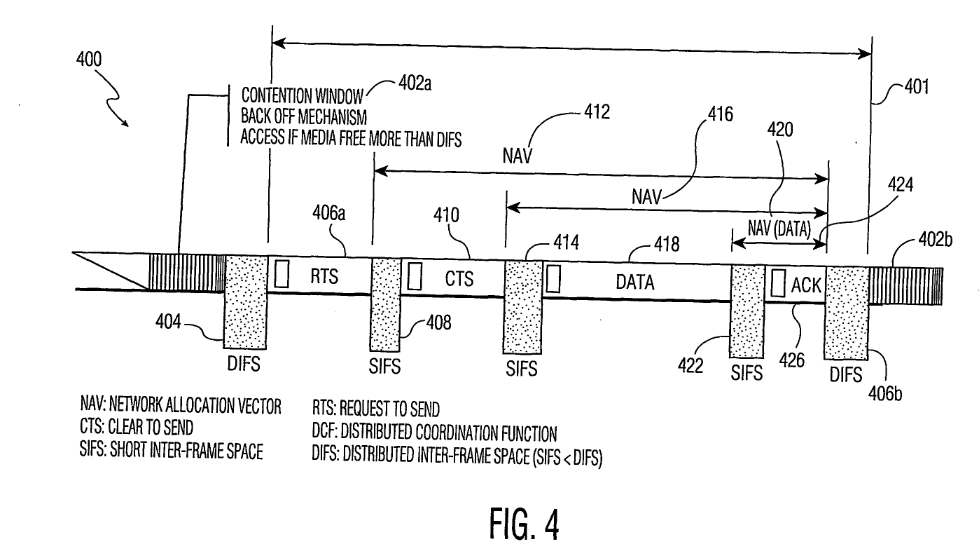

FIG. 4 illustrates a typical transport packet assemblage 400 for a distributed random access control as specified by the IEEE 802.11 standards. A contention packet provides the backoff mechanism used to provide the likelihood that the medium is free for transmission and corresponding reception by an AP and wireless station, respectively. Once the medium is seen as free, the wireless station sends a data transaction preceded by a RTS 406a and a CTS 410 phase. RTS 406a is transmitted from source to a destination station and CTS 410 is a response initiated by the destination station to the source station. In each packet (RTC 406a, CTS 410, and Data 418) a duration ID field DIFS 404 present in the packet 400 header indicates the potential duration of the on going transaction in such a way that any wireless station maintaining a Network Allocation Vector (NAV) such as NAV 412 will not attempt to acquire the medium during the first transaction duration 401 as measured from the start of RTS 406a to the end of DIFSb thus avoiding potential contentions. Once the CTS 410 is received and a short inter-frame space SIFS 408 duration data 418 is transmitted, the end of which is followed by a short inter-frame space SIFS 422 duration and the reception of Ack 426 from the receiver. The cycle, paralleling transaction 401 proceeds to repeat itself after distributed inter-frame space 406b duration. A contention backoff mechanism 402b follows the DIFS 406b. FIG. 4 also illustrates the NAVs at different stages of the transaction 401, such as NAV 412, NAV 416 and NAV 424.

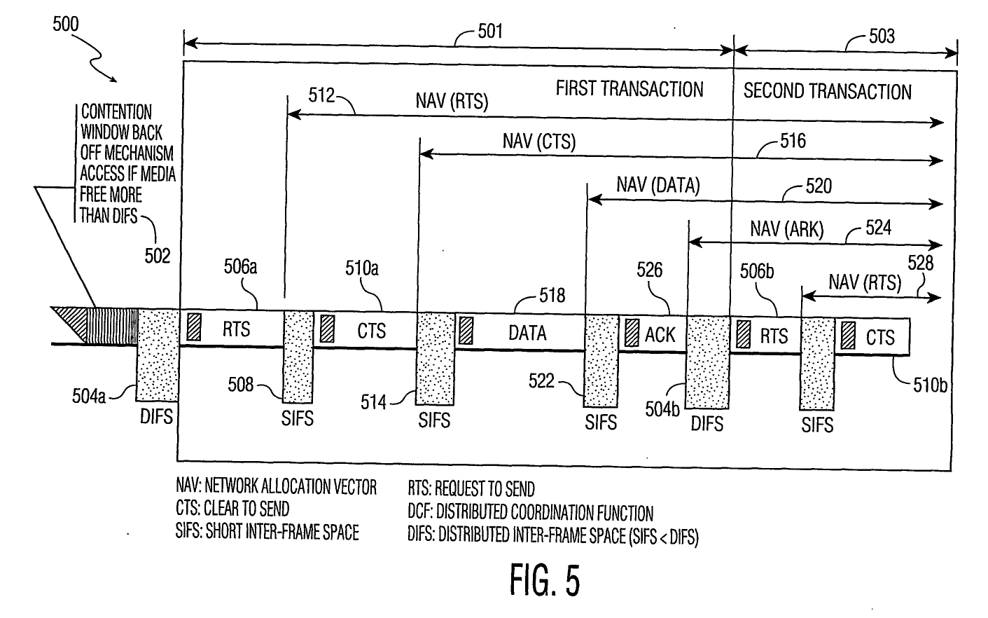

FIG. 5 illustrates a fixed access control packet assemblage 500 of the present invention compatible in an IEEE 802.11 specified environment. A contention packet provides the backoff mechanism used to provide the likelihood that the medium is free for transmission and corresponding reception by an AP and wireless station, respectively. Once the medium is seen as free, the wireless station sends a data transaction preceded by a RTS 506a and a CTS 510 phase. RTS 506a is transmitted from source to a destination station and CTS 510 is a response initiated by the destination station to the source station. In each packet (RTC 506a, CTS 510, and Data 518) a duration ID field present in the packet 500 header indicates the potential duration of the on going transaction in such a way that any wireless station maintaining a Network Allocation Vector (NAV) such as NAV 512 will not attempt acquire the medium during, at least, the first transaction duration 501 as measured from the start of RTS 506a to the end of DIFSb 504b and by way of example, the second transaction 503. This extended fixed duration is due to the setting of the NAV counter to over estimate the duration of a first transaction so as to window one or more transactions before releasing the medium, thus avoiding potential contentions. Once the CTS 510a is received and a short inter-frame space SIEFS 508 duration data 518 is transmitted, the end of which is followed by a short inter-frame space SIFS 522 duration and the reception of Ack 526 from the receiver. The cycle, paralleling transaction 501 proceeds to repeat itself after distributed inter-frame space DIES 504b duration. Note the absence of a contention backoff mechanism following DIFS 504b. FIG. 5 also illustrates the NAVs at different stages of the transaction 501, such as NAV 512, NAV 516, NAV 520 and NAV 524 and NAV 528.

In referring to FIG. 2 and FIG. 5, a node 230 that functions as a controller (e.g. an AP) retains the control of the medium even after a simple data transaction using the duration ID field where the duration indicates the largest possible value for one transaction, that is (2¹⁵−1) or 32767, in accordance with the IEEE 802.11 standard. Note that there is no back off or contention window between the first transaction 501 and the second transaction 503. Note also that the gap between the two transactions is DIFS 504b, but could be also SIFS 522 depending on implementation. For the second transaction 503 the controller, such as an access point (not shown), can be programmed to decide to adjust the duration ID value in order to release the medium (the channel) after this second transaction 503. It can also can be programmed to decide to hold the medium and, in that case, the duration ID would indicate the largest possible value that is (2¹⁵−1) or 32767, in accordance with the IEEE 802.11 standard, and so on until the controller as programmed decides to releases the medium. This mechanism would allow bandwidth provisioning in the access point in order to provide QOS for a downstreaming service, for example.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims. For example, although the invention is described in the context of IEEE 802.11 based WLANs, it is to be understood that the invention may be applied to structures based on other wireless LAN standards wherein the synchronization is to be maintained.

1-11. (canceled)

12. A method for reducing contention conflicts in a broadcast/multicast wireless network comprising the steps of: coordinating by an access point a contention-free communication by the access point by computing a time duration and communicating the duration in the distributed inter-frame space interval to one or more wireless stations such that a communication stream to at least one of the wireless stations is uninterrupted for the duration, wherein the duration information is used to control a counter in a wireless station to prevent the wireless station from attempting to transmit for a predetermined period of time.

13. A method for reducing contention conflicts in a broadcast/multicast wireless network between a wireless station and an access point comprising the steps of: receiving digital packets from an access point embedded in a program, receiving a computed duration in a distributed inter-frame space interval for transmission of a plurality of broadcast/multicast frames, controlling a network allocation counter in response to the computed duration, and receiving a communication stream that is uninterrupted for the duration in response to the state of the network allocation counter.

14. The method in claim 12 further including the step of: imbedding at least one network allocation vector duration information in an IEEE 802.11 compliant data packet for transmission of an uninterrupted plurality of the broadcast/multicast frames to wireless stations to reduce contention conflicts among IEEE 802.11 compliant wireless stations.

15. An access point that receives digital packets embedded in a transmission stream comprising: a means to receive digital packets; a means for computing a duration for transmission of a plurality of broadcast/multicast frames, the duration controlling a network allocation counter in a plurality of devices associated with a wireless network; a means to communicate the duration in a distributed inter-frame space interval to one or more wireless stations in a header packet to reduce contention conflicts among the wireless stations.

16. An access point that receives digital packets embedded in a transmission stream comprising: a network allocation counter; a means for receiving duration for transmission of a plurality of broadcast/multicast frames of a video frame transmission for downlinking an uninterrupted plurality of broadcast/multicast frames; and means for controlling the network allocation counter in response to the duration, and controlling attempts to access the network in response to the network allocation counter.

17. The access point according to claim 16, wherein the network allocation counter corresponds to an IEEE 802.11 compliant network allocation vector.

18. An access point that receives digital packets embedded in a transmission stream comprising a node that retains control of a medium by fixing a duration field and whereby the node can adjust the duration field to release the medium.

19. The access point of claim 18, wherein the node can fix a duration to hold the medium until the node decides to releases the medium.

20. The access point of claim 18, wherein the node permits bandwidth provisioning in the node in order to provide quality of service for a downstreaming service.

21. The access point of claim 18, wherein the duration is the largest possible period, in accordance with a wireless communication standard.

22. A method for reducing contention conflicts in a broadcast/multicast wireless transmission comprising the steps of coordinating by an access point in a first cell a contention-free session, each said contention-free session including multiple transmissions with other member stations in the first cell, using interframe spaces of sufficient duration such that a single duration during a session delivers the broadcast/multicast information in a single communication stream eliminating the requirement for contending for the medium for each broadcast/multicast frame transmission.

23. A mobile terminal comprising means to receive a computed duration for transmission of a plurality of broadcast/multicast frames, wherein said computed duration controls a counter in a plurality of devices associated with a wireless network including said mobile terminal.

24. The mobile terminal according to claim 23, further wherein a communication stream to at least one of said plurality of devices associated with said wireless network is uninterrupted for said computed duration.

25. The mobile terminal according to claim 23, further wherein said counter is a network allocation counter.

26. The mobile terminal according to claim 23, further wherein said counter prevents all but one of said plurality of devices associated with said wireless network from attempting to transmit for a predetermined period of time.
